(19) United States
(12) Patent Application Publication
(10) Pub. No.: US 2017/0160825 A1
(43) Pub. Date: Jun. 8, 2017

(54) METAL MESH SENSING MODULE OF TOUCH PANEL AND MANUFACTURING METHOD THEREOF

(71) Applicant: JTOUCH Corporation, Taoyuan City (TW)

(72) Inventors: Yu-Chou Yeh, Taoyuan City (TW); Ting-Ching Lin, Taoyuan City (TW); Yi-Chin Chen, Taoyuan City (TW); Jia-Hao Kang, Taoyuan City (TW)

(21) Appl. No.: 15/068,135

(22) Filed: Mar. 11, 2016

(30) Foreign Application Priority Data
Dec. 4, 2015 (TW) 104140646

(51) Int. Cl. G06F 3/041

(52) U.S. Cl. CPC G06F 3/041; G06F 2203/04103; G06F 2203/04112

(57) ABSTRACT

A metal mesh sensing module of a touch panel and a manufacturing method thereof are disclosed. Plural first referring nodes and plural first referring points are defined on a first surface. Plural second referring nodes and plural second referring points are defined on a second surface. The first and second referring nodes are arranged in regular order and have their vertical projections in staggered arrangement. The first referring point and second referring point are located at the midpoint between two adjacent first referring nodes and second referring nodes respectively and have the same vertical projections. A shiftable zone is defined for obtaining plural first turning points, wherein each first turning point is randomly selected from the shiftable zone having the center aligned to the corresponding first referring point. A first mesh pattern is obtained by connecting each first referring node to adjacent first turning points.

### FIELD OF THE INVENTION

The present invention relates to a metal mesh sensing module of a touch panel and a manufacturing method thereof, and more particularly to a metal mesh sensing module of a touch panel for reducing Moire effect and a manufacturing method thereof.

### BACKGROUND OF THE INVENTION

Nowadays, touch control technologies are widely applied to the touch display devices of various electronic products in order to facilitate the users to control the operations of the electronic products. Moreover, for achieving the displaying function and making the sensing electrodes of the visible touch zone unrecognizable, transparent sensing electrodes are usually used as the electrodes of the touch zone of the display panel. For example, the transparent sensing electrodes are made of indium tin oxide (ITO). As the trend of designed touch panel is developed toward the large-sized touch panel, the uses of the ITO transparent electrodes have some drawbacks. For example, the resistance value is increased and the sensing response speed is reduced. In addition, since the method of fabricating the large-sized touch panel with the ITO transparent electrodes needs many steps, the fabricating cost is increased. Consequently, a metal mesh sensing electrode is gradually employed to replace the ITO transparent electrode.

However, when the metal mesh sensing module of the touch panel is attached on a display module, a Moire effect is readily generated. The displaying quality is adversely affected by the Moire effect. As known, the profiles of the mesh pattern of the metal mesh sensing module may influence the generation of moire. Generally, if the adjacent mesh patterns are regularly arranged, the possibility of generating the Moire effect increases. Moreover, if the wire width of the mesh pattern increases or the adjacent patterns overlap or crisscross with each other, the possibility of generating the Moire effect also increases. Moreover, if the metal mesh sensing module of the touch panel and the thin film transistor array (e.g. the black matrix or the RGB pixel array) of the display module both are regular mesh structures, the possibility of generating the Moire effect would also increase when the touch panel is attached on the display module and these two regular mesh structures are overlapped with each other.

For avoiding or minimizing the Moire phenomenon, the mesh pattern profiles of the metal mesh sensing module of the touch panel may be designed according to the thin film transistor array of the display module. In particular, for increasing the visibility, plural linear metal lines are regularly arranged in a crisscrossed form so as to define the mesh pattern of the metal mesh sensing module. For example, the mesh pattern comprises plural linear first metal lines and plural linear second metal lines. The plural linear first metal lines are oriented along a first direction and in parallel with each other. The plural linear second metal lines are oriented along a second direction and in parallel with each other. The plural linear first metal lines and the plural linear second metal lines are crisscrossed and isolated with each other. Consequently, a touch-sensitive array pattern is defined by the plural linear first metal lines and the plural linear second metal lines collaboratively. As mentioned above, the mesh pattern of the metal mesh sensing module of the touch panel should be arranged to match the thin film transistor array of the display panel for reducing the Moire phenomenon. Under this circumstance, the spacing intervals between the plural metal lines and the crisscrossing angles of the metal lines should be elaborately designed. In other words, the designing complexity increases. The visibility is readily reduced because of the error designing of the mesh pattern of the metal mesh sensing module. On the other hand, if the mesh pattern of the metal mesh sensing module is designed by random patterns for solving the problem of interference, the designed mesh pattern will have the mesh opening with abnormal aperture ratio and unequal distribution, and cause the phenomenon of uneven light intensity. When several random-designed patterns are combined with each other, it is not easy to splice them together or the interference will be introduced, because each interface among spliced patterns has nodes selected randomly.

Therefore, there is a need of providing an improved metal mesh sensing module of a touch panel and a manufacturing method thereof in order to overcome the above drawbacks.

### SUMMARY OF THE INVENTION

The present invention provides a metal mesh sensing module of a touch panel and a manufacturing method thereof. By randomly designing the mesh pattern of the metal mesh sensing module, the possibility of generating the interference caused by the overlapping or cross points of patterns is avoided.

The present invention further provides a metal mesh sensing module of touch panel and a manufacturing method thereof. The possibility of generating the mesh opening with abnormal aperture ratio and unequal distribution in random-designed mesh patterns will be avoided by controlling the random designed mesh pattern of the metal mesh sensing module precisely in a specific condition. Consequently, the phenomenon of uneven light intensity will be avoided while the metal mesh sensing module is applied to a touch display apparatus.

The present invention further provides a metal mesh sensing module of a touch panel and a manufacturing method thereof. Since the random designed patterns of the metal mesh sensing module can be controlled precisely by using specific shiftable zone, there won't be abnormal opening and spliced mark generated in the spliced interface of the mesh patterns while more than two random-designed mesh patterns are spliced together. The interference caused by the interface between two spliced patterns is avoided and the visibility is not influenced.

The present invention further provides a touch panel of sensing electrode and a manufacturing method thereof. The mesh patterns can be designed according to the arrangement of pixel units in a display panel for reducing the Moire effect and enhancing the visibility.

In accordance with an aspect of the present invention, there is provided a metal mesh sensing module. The metal mesh sensing module includes a transparent substrate, at least a first mesh pattern, and at least a second mesh pattern. The transparent substrate has a first surface and a second surface. The first mesh pattern is disposed on the first surface and has plural first referring nodes, plural first referring points, and plural first turning points. Plural first referring nodes are arranged in regular order, and each first referring point is located at the midpoint between two adjacent first referring nodes. The second mesh pattern is disposed on the second surface and has plural second referring nodes and plural second referring points. The plural second referring nodes are arranged in regular order, and each second referring point is located at the midpoint between two adjacent first referring nodes. The plural first referring nodes and the plural second referring nodes have their vertical projections in staggered arrangement, and the plural first referring points and the plural second referring points have the same vertical projections. Each first referring point is corresponding to a shiftable zone, and each first turning point is randomly selected from the shiftable zone having the center aligned to the corresponding first referring point on the first surface and connected with adjacent first referring nodes on the first surface, so as to form the first mesh pattern.

In accordance with an aspect of the present invention, there is provided a manufacturing method of a metal mesh sensing module. Plural first referring nodes and first referring points are defined on a first surface. Plural second referring nodes and second referring points are defined on a second surface. The plural first referring nodes and the plural second referring nodes are arranged in regular order and have their vertical projections in staggered arrangement. Each first referring point and each second referring point are located at the midpoint between two adjacent first referring nodes and two adjacent second referring nodes and have the same vertical projections. A shiftable zone is defined corresponding to each first referring point for obtaining plural first turning points, wherein each first turning point is randomly selected from the shiftable zone having the center aligned to the corresponding first referring point. A first mesh pattern is obtained by connecting each first referring node to adjacent first turning points.

The above contents of the present invention will become more readily apparent to those ordinarily skilled in the art after reviewing the following detailed description and accompanying drawings, in which:

### BRIEF DESCRIPTION OF THE DRAWINGS

FIG. 1 shows a flow chart of manufacturing a metal mesh sensing module of a touch panel according to the first embodiment of the present invention;

FIGS. 2A to 2F schematically illustrate the structure of the metal mesh sensing module of the touch panel in different steps of FIG. 1;

FIG. 3A illustrates an exemplary metal mesh sensing circuit having plural spliced mesh patterns;

FIG. 3B schematically illustrates an exemplary metal mesh sensing module having two opposite sensing electrodes;

FIG. 4 shows a flow chart of manufacturing a metal mesh sensing module of a touch panel according to the second embodiment of the present invention;

FIGS. 5A to 5D schematically illustrate the structure of the metal mesh sensing module of the touch panel at different steps of FIG. 4;

FIG. 6 shows a flow chart of manufacturing a metal mesh sensing module of a touch panel according to the third embodiment of the present invention;

FIGS. 7A to 7D schematically illustrate the structure of the metal mesh sensing module of the touch panel at different steps of FIG. 6; and

FIG. 8 schematically illustrates the relative arrangement of the metal mesh sensing module of FIG. 1 and the pixel units of a display module according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

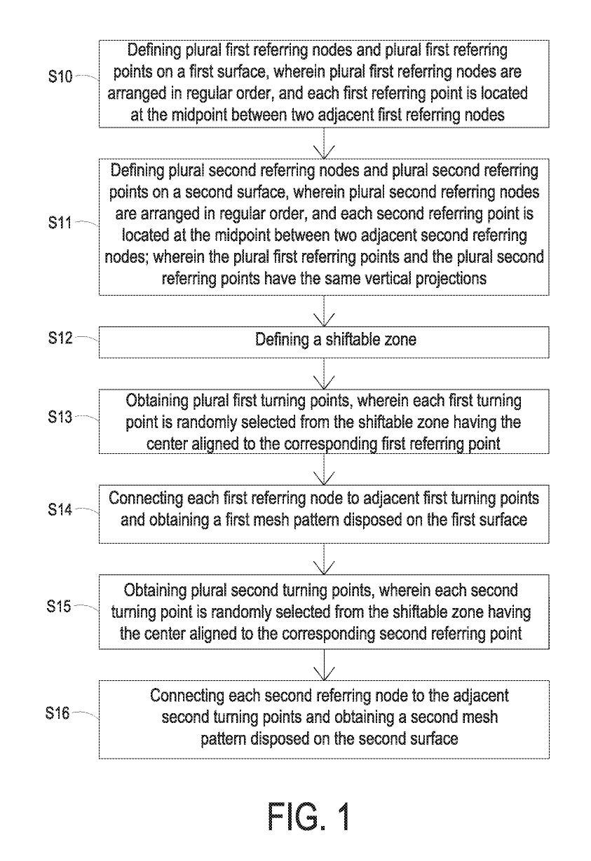

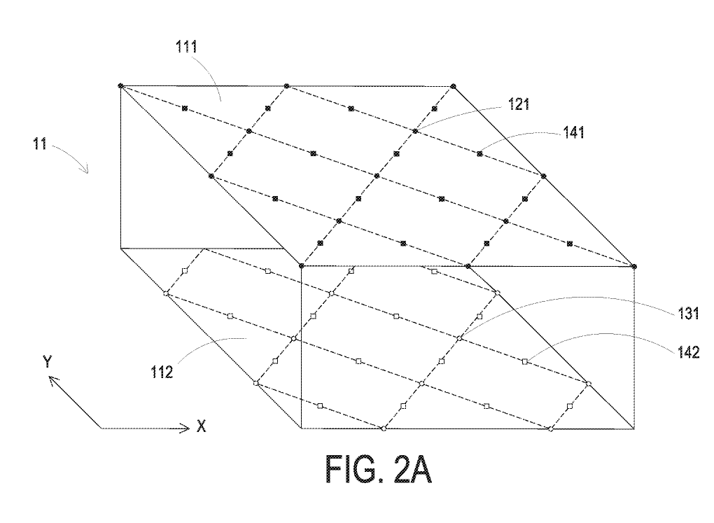

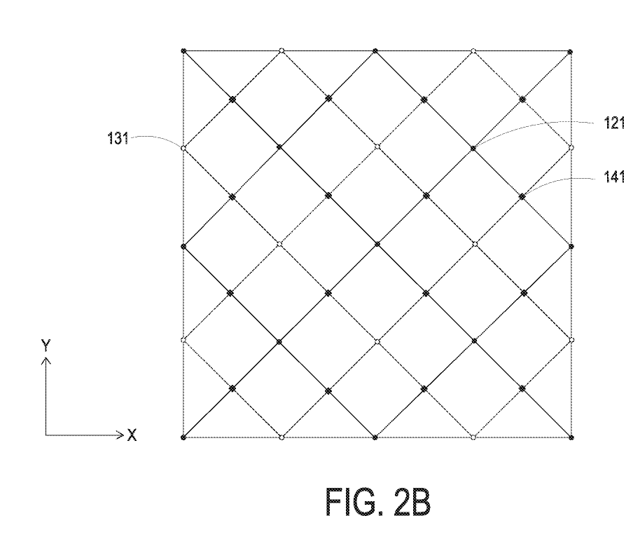

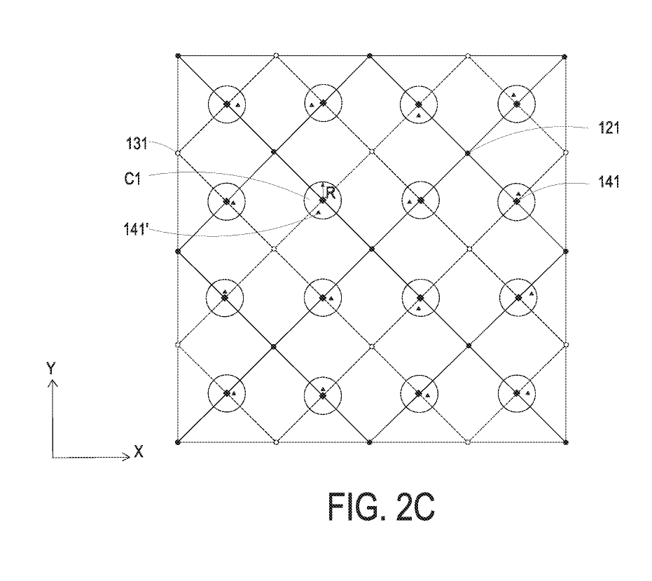

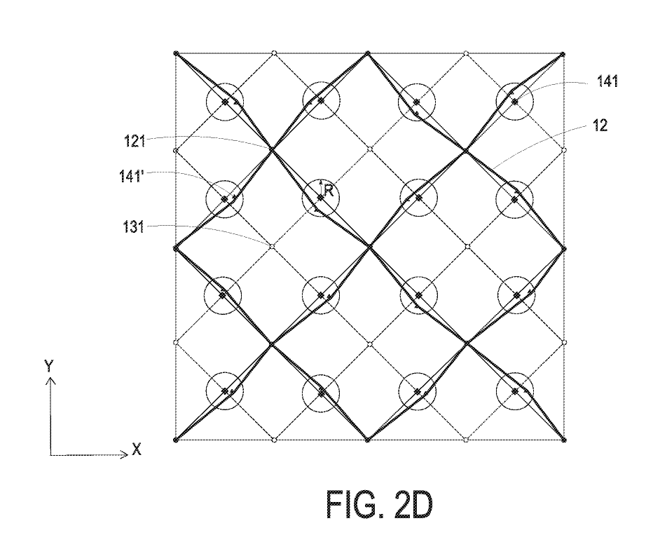

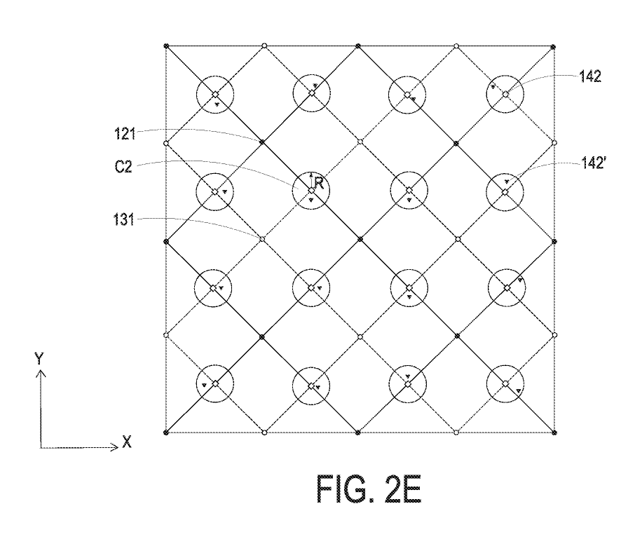

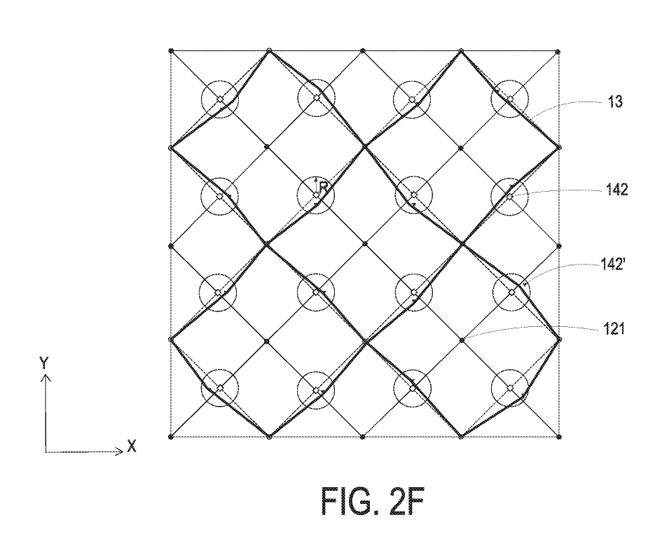

FIG. 1 shows a flow chart of manufacturing a metal mesh sensing module of a touch panel according to the first embodiment of the present invention. FIGS. 2A to 2F schematically illustrate the structure of the metal mesh sensing module of the touch panel in different steps of FIG. 1. As shown in FIGS. 1, 2A and 2B, a transparent substrate 11 is provided. The transparent substrate 11 has a first surface 111 and a second surface 112. Plural first referring nodes 121 and plural first referring points 141 are defined on the first surface 111 (as shown in the step S10). In this step, the plural first referring nodes 121 are arranged in regular order, and each first referring point 141 is located at the midpoint between two adjacent first referring nodes 121. Then, plural second referring nodes 131 and plural first referring points 142 are defined on the second surface 112 (as shown in the step S11). In this step, the plural second referring nodes 131 are arranged in regular order, and each second referring point 142 is located at the midpoint between two adjacent second referring nodes 131. In this embodiment, as shown in FIGS. 1, 2A and 2B, the plural first referring nodes 121 disposed on the first surface 111 are arranged as diamond arrays extending along but not limited to X-Y axis. In some embodiments, any extendable array, for example but not limited to triangular arrays, square arrays, rectangle arrays, hexagonal arrays or octagonal arrays, is suitable to be implemented. The arrangement of the plural second referring nodes 131 disposed on the second surface 112 is similar to the above one, and is not redundantly described herein. In the embodiment, the first referring nodes 121 and the second referring nodes 131 have their vertical projections in staggered arrangement, and the plural first referring points 141 and the plural second referring points 142 have the same vertical projections. Then, as shown in FIGS. 2C to 2F, a shiftable zone C1, C2 is defined (as shown in the step S12). In the embodiment, the shiftable zone C1, C2 is a circle area defined by a predetermined radii R. Then, as shown in FIGS. 1 and 2C, plural first turning points 141′ are obtained corresponding to plural first referring points 141, wherein the center of the shiftable zone C1 is aligned to each first referring point 141, and each first turning point 141′ is randomly selected from the shiftable zone C1 having the center aligned to the corresponding first referring point 141 (as shown in the step S13). Afterward, each first referring node 121 is connected to the adjacent first turning points 141′ on the first surface 111 and the first mesh pattern 12 is formed on the first surface 111 for a metal mesh sensing circuit (as shown in the step S14).

Similarly, as shown in FIGS. 1, 2A and 2E, the second mesh pattern 13 is formed on the second surface 112. The center of the shiftable zone C2 is aligned to each second referring point 142, and each second turning points 142′ is randomly selected from the shiftable zone C2 of the corresponding second referring point 142 (as shown in the step S15). Then, as shown in FIGS. 1 and 2F, each second referring node 131 is connected to the adjacent second turning points 142′ on the second surface 112 and the second mesh pattern 13 is formed on the second surface 112 for the metal mesh sensing circuit (as shown in the step 16).

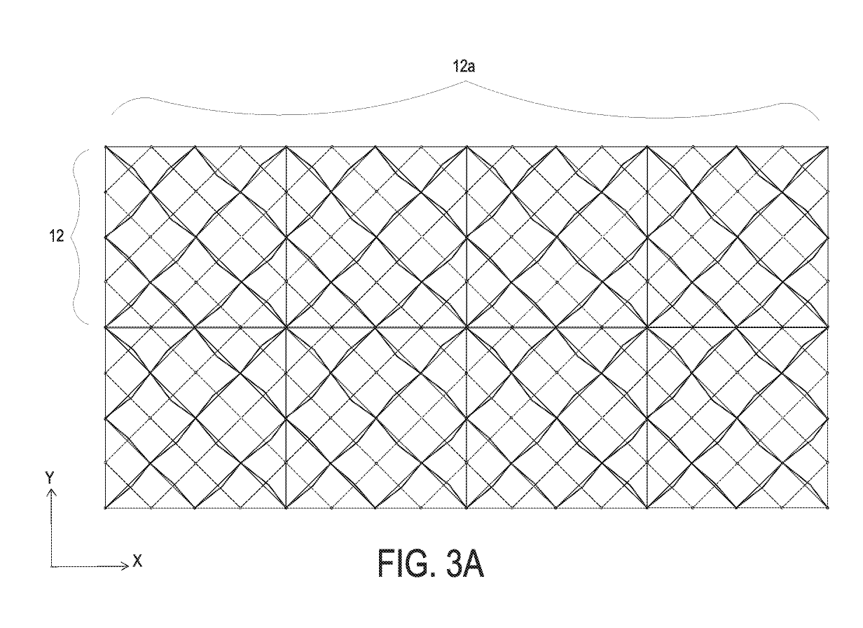

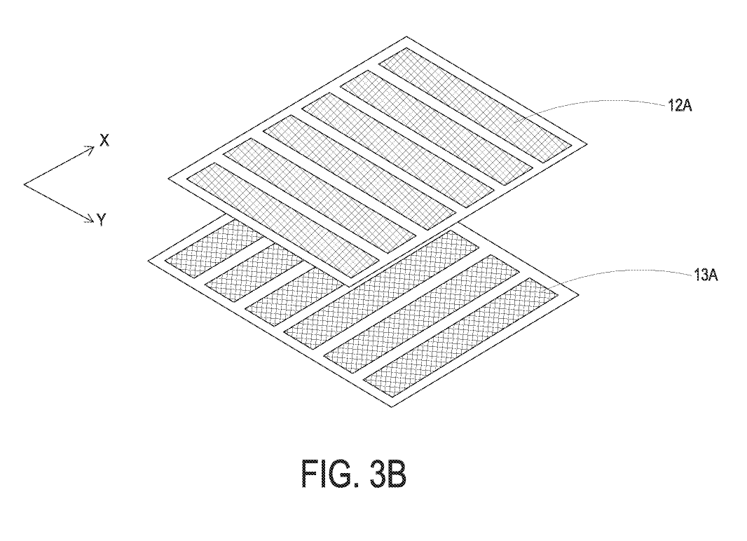

In some embodiments, the first mesh pattern 12 disposed on the first surface 111 and the second mesh pattern 13 disposed on the second surface 112 are regarded as the mesh patterns having random and unrepeated units. FIG. 3A illustrates an exemplary metal mesh sensing circuit having plural spliced mesh patterns. Two adjacent mesh patterns are spliced by overlapping the referring nodes located at the spliced interface. Plural first mesh patterns 12 are spliced along a first direction (such as X axis) or a second direction (such as Y axis) to obtain the larger combined metal mesh sensing circuit. In the embodiment, the first metal mesh sensing circuit 12a is formed by but not limited to 8 (i.e. 2×4=8) first mesh patterns 12. FIG. 3B schematically illustrates an exemplary metal mesh sensing module having two opposite sensing electrodes. The first sensing electrodes 12A and the second sensing electrode 13A disposed on different surfaces are consisted of plural first metal mesh sensing circuits and plural second metal mesh sensing circuits, respectively, and each of the first metal mesh sensing circuit and each of the second metal mesh sensing circuits are consisted of plural first mesh patterns 12 and plural second mesh patterns 13 having random and unrepeated mesh units, respectively. In the embodiment, the shiftable zone C1 and the shiftable zone C2 are circle areas defined by the same predetermined radii R. The first mesh pattern 12 and the second mesh pattern 13 have plural first referring nodes 121 and plural second referring nodes 131 arranged in regular order, respectively. When the first mesh pattern 12 or the second mesh pattern 13 is spliced with another one, the referring nodes located at the spliced interface thereof and arranged in regular order can be easily jointed with each other. Consequently, the difficulties of splicing or the abnormal mesh opening caused by the conventional excessive-random and shifted nodes and the spliced mark caused while mesh patterns are designed to splice together can be avoided. Afterward, the mesh pattern shown in FIG. 3B is transferred and formed on the transparent substrate by a photolithography process and etching process. In the embodiment, the predetermined radii R is defined according to the line spacing, i.e. the distance between any two adjacent first referring nodes 121 or any two adjacent second referring nodes 131, of the mesh pattern. The predetermined radii R and the distance between any two adjacent first referring nodes or any two adjacent second referring nodes have a specific ratio ranged from 0.5% to 12.5%, and more perfectly ranged from 1% to 10%. Namely, the predetermined radii R is ranged from 3 um to 50 um, and more perfectly ranged from 5 um to 30 um.

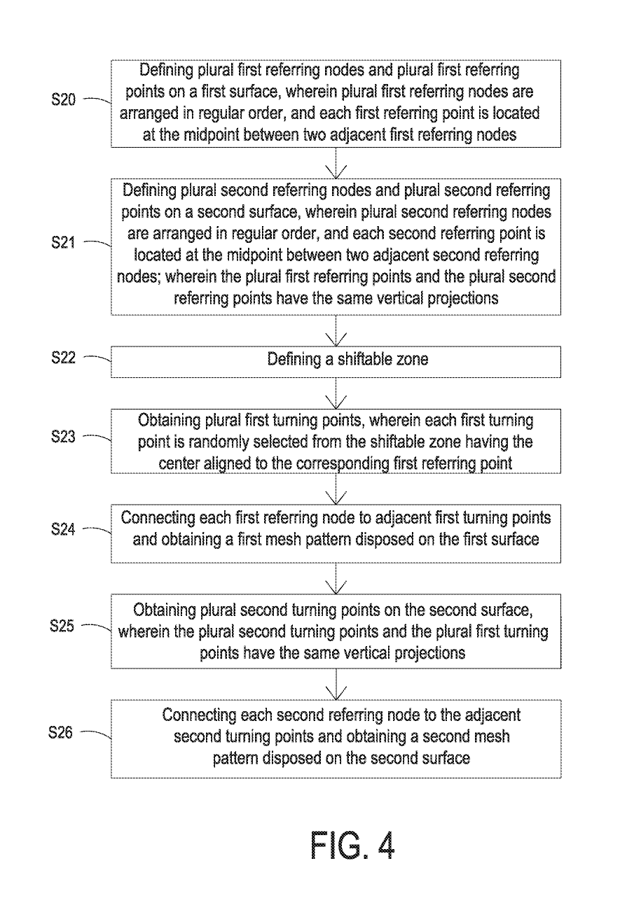

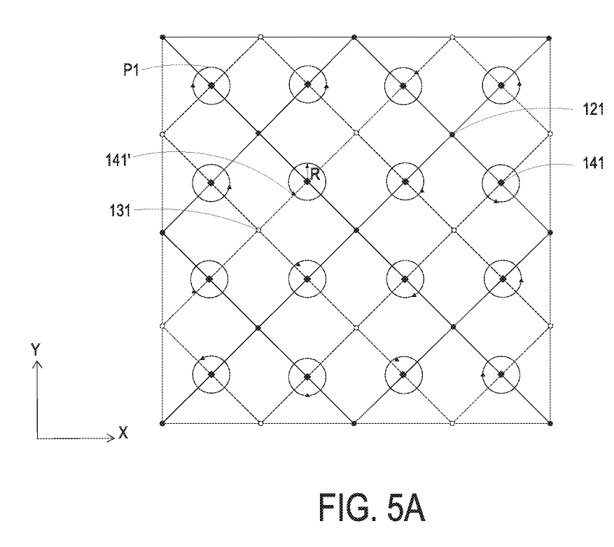

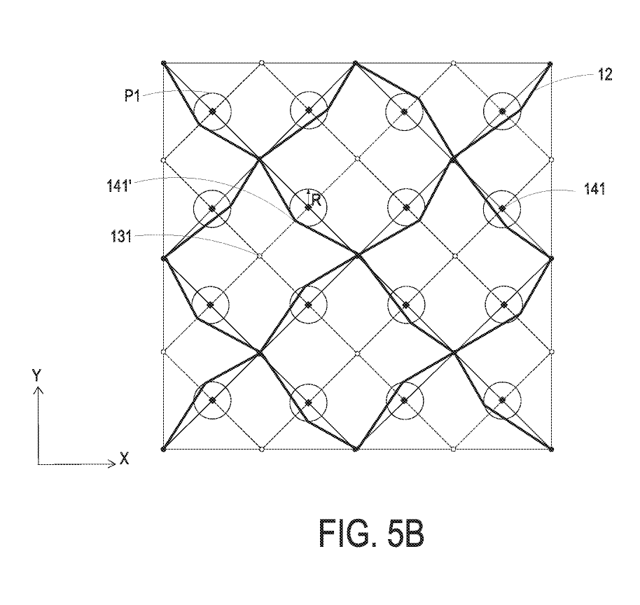

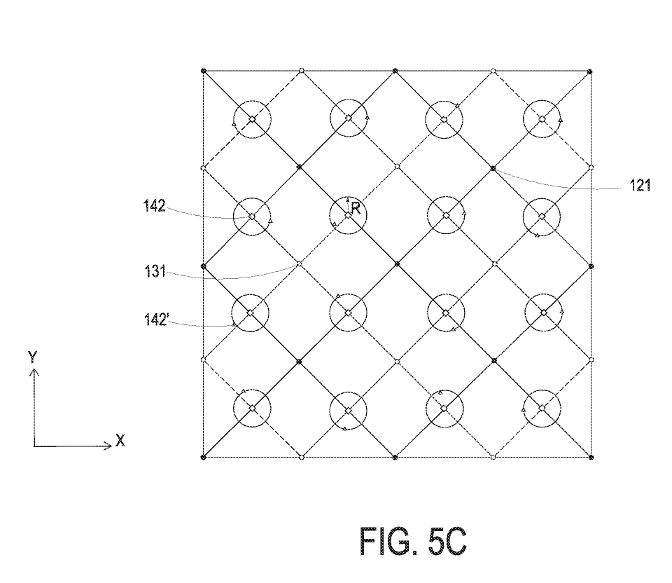

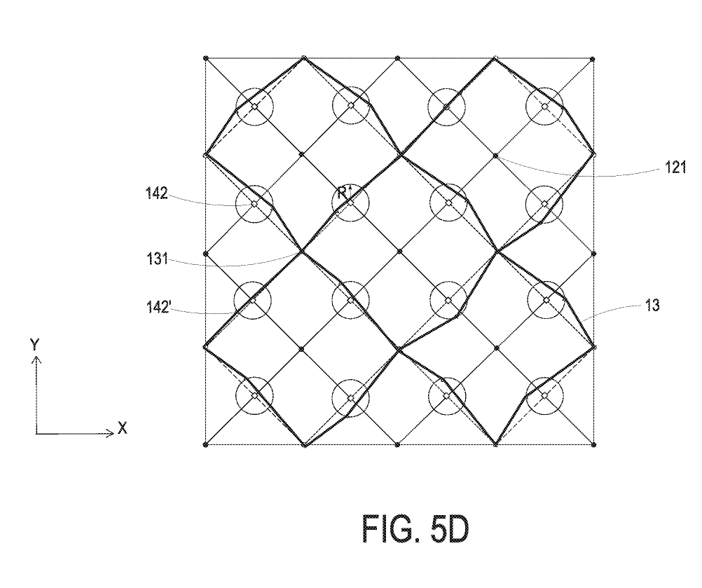

FIG. 4 shows a flow chart of manufacturing a metal mesh sensing module of a touch panel according to the second embodiment of the present invention. FIGS. 5A to 5D schematically illustrate the structure of the metal mesh sensing module of the touch panel at different steps of FIG. 4. The manufacturing method of the metal mesh sensing module of the touch panel is simply described as the following. As shown in FIGS. 4 and 5A, a transparent substrate 11 having a first surface 111 and a second surface 112 (as shown in FIG. 2A) is provided, and plural first referring nodes 121 and plural first referring points 141 are defined on the first surface 111 (as shown in the step S20). Similarly, in the embodiment, the plural first referring nodes 121 are arranged in regular order, and each first referring point 141 is located at the midpoint between two adjacent first referring nodes 121. Then, plural second referring nodes 131 and plural first referring points 142 are defined on the second surface 112 (as shown in the step S21). In this step, the plural second referring nodes 131 are also arranged in regular order, and each second referring point 142 is located at the midpoint between two adjacent second referring nodes 131. In this embodiment, as shown in FIGS. 4 and 5A, the plural first referring nodes 121 disposed on the first surface 111 are arranged as diamond arrays extending along but not limited to X-Y axis. In some embodiments, any extendable array, for example but not limited to triangular arrays, square arrays, rectangle arrays, hexagonal arrays or octagonal arrays, is suitable to be implemented. The arrangement of the plural second referring nodes 131 disposed on the second surface 112 is similar to the above one, and is not redundantly described herein. In the embodiment, the plural first referring nodes 121 and the second referring nodes 131 have their vertical projections in staggered arrangement, and the plural first referring points 141 and the plural second referring points 142 have the same vertical projections. Then, a shiftable zone P1 is defined (as shown in the step S22). In the embodiment, the shiftable zone P1 is a circumference defined by a predetermined radii R. Afterward, plural first turning points 141′ are obtained corresponding to the plural first referring points 141, wherein the center of the shiftable zone P1 is aligned to each first referring point 141, and each first turning point 141′ is randomly selected from the shiftable zone P1 having the center aligned to the corresponding first referring point 141 (As shown in the step S23). Then, as shown in FIGS. 4 and 5B, each first referring node 121 is connected to the adjacent first turning points 141′ on the first surface 111 and the first mesh pattern 12 is formed on the first surface 111 for a metal mesh sensing circuit. (As shown in the step S24).

On the other hand, as shown in FIGS. 4 and 5C, the second mesh pattern 13 is formed on the second surface 112. Plural second turning points 142′ are defined by projecting the plural first turning points 141′ on the second surface 112 (As shown in the step S25). Namely, plural first turning points 141′ disposed on the first surface 111 and plural second turning points 142′ disposed on the second surface 112 have the same vertical projections. Then, as shown in FIGS. 4 and 5D, each second referring node 131 is connected to the adjacent second turning points 142′ on the second surface 112 and the second mesh pattern 13 is formed on the second surface 112 for the metal mesh sensing circuit. (As shown in the step 26).

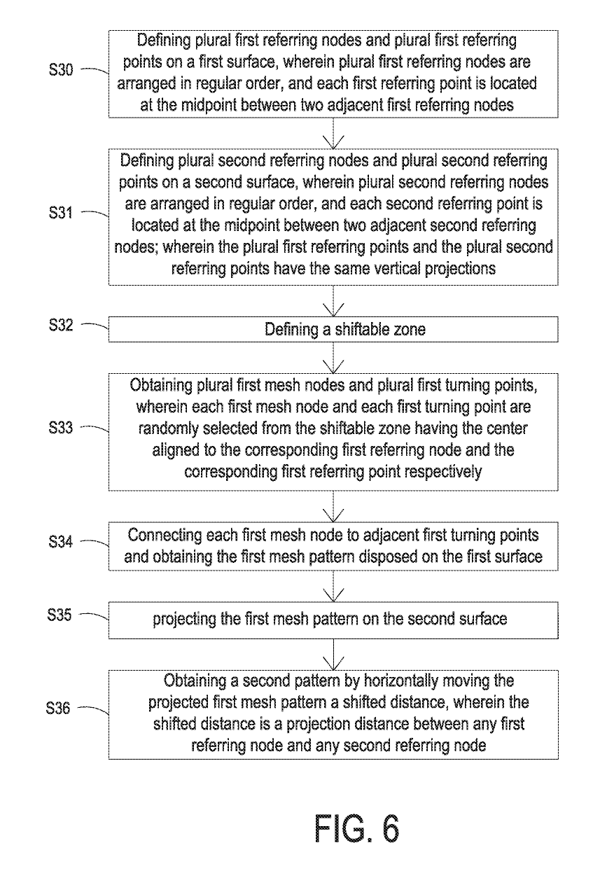

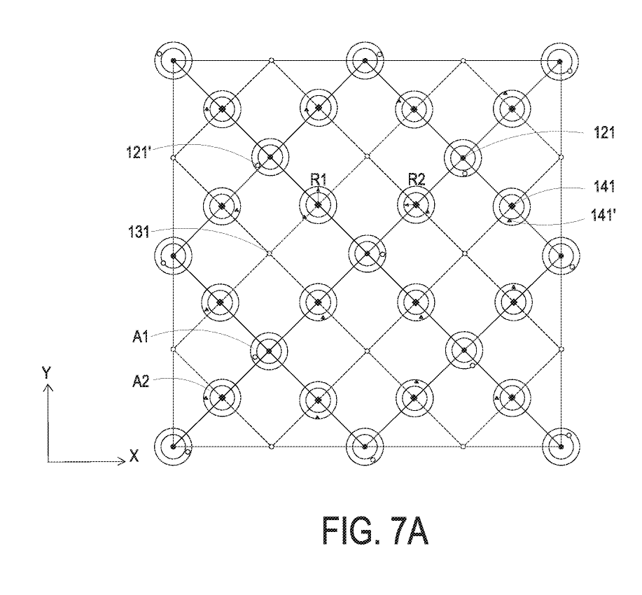

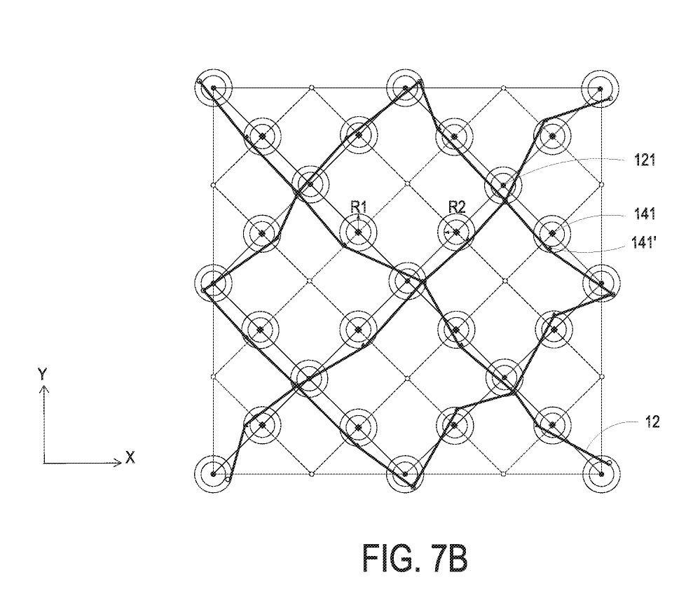

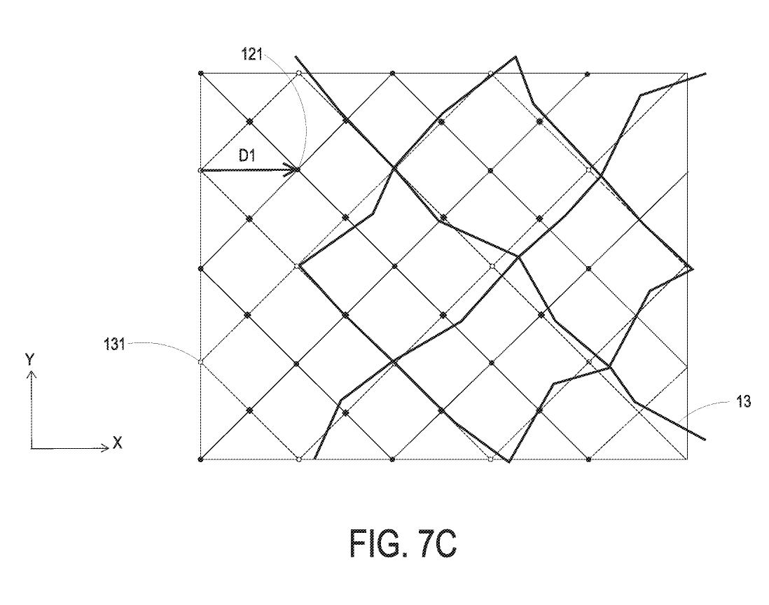

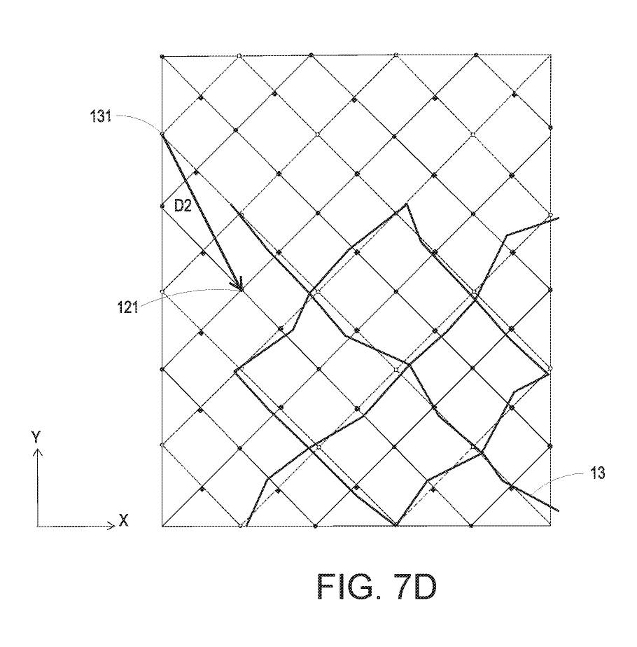

FIG. 6 shows a flow chart of manufacturing a metal mesh sensing module of a touch panel according to the third embodiment of the present invention. FIGS. 7A to 7C schematically illustrate the structure of the metal mesh sensing module of the touch panel at different steps of FIG. 6. As shown in FIGS. 6, 7A and 7B, similar to the above embodiments, the first mesh pattern 12 is formed on the first surface 111 of the transparent substrate 11 (Please refer to FIG. 2A). In the embodiment, the manufacturing steps S30 to S32 are the same as the steps S10 to S12 of FIG. 1, and are not redundantly described herein. After the steps S30 to S32 are executed, a shiftable zone A1, A2 is defined. Comparing with the above embodiments, the shiftable zone A1, A2 of this embodiment is a ring area defined by a first predetermined radii R1 and a second predetermined radii R2. Consequently, the center of the shiftable zone A1 is aligned to each first referring node 121 on the first surface 111, and the center of the shiftable zone A2 is aligned to each first referring point 141 on the first surface 111. As shown in FIGS. 6 and 7A, each first mesh node 121′ is randomly selected from the shiftable zone A1 having the center aligned to each corresponding first referring node 121, and each first turning point 141′ is randomly selected from the shiftable zone A2 having the center aligned to each corresponding first referring point 141 at the same time (As shown in the step S33). Then, as shown in FIGS. 6 and 7B, each first mesh node 121′ is connected to the adjacent first turning points 141′ on the first surface 111 and the first mesh pattern 12 is formed on the first surface 111 for a metal mesh sensing circuit (As shown in the step S34). On the other hand, the second mesh pattern 13 is formed on the second surface 112 of the transparent substrate 11. Comparing with the above embodiments, in this embodiment, the first mesh pattern 12 disposed on the first surface 111 is projected to the second surface 112 (as shown in the step S35). Then, as shown in FIGS. 6 and 7C, the projected first mesh pattern 12 is horizontally moved a shifted distance D1, D2 on the second surface 112, wherein the horizontal movement of the projected first mesh pattern 12 can be a direction along but not limited to X axis, Y axis or any quadrant of X-Y coordinate system (as shown in the step S36). The shifted distance D1, D2 is a projection distance from any first referring node 121 to any second referring node 131. As shown in the embodiment of FIG. 7C, the horizontal movement of the projected first mesh pattern 12 is executed along but not limited to X axis from the original position. In this embodiment, the shifted distance D1 is the projection distance from the first referring node 121 to the second referring node 131, and the second mesh pattern 13 is formed on the second surface 112. In some embodiments, the shifted distance D2 is a projection distanced from any first referring node 121 to any second referring node 131. In the embodiment of FIG. 7D, the first mesh pattern 12 is projected on the second surface 122 and horizontally moved a shifted distance D2 along the fourth quadrant of X-Y coordinate system from the original position, and then the second mesh pattern 13 is obtained on the second surface 112. The present invention is not limited to the above embodiments. After the first mesh pattern 12 is projected on the second surface 112, the horizontal movement can be executed not only along a direction lied in the fourth quadrat (in the lower right corner) of X-Y coordinate system from the original projected position, but also along a direction lied in the first quadrat (in the upper right corner), the second quadrat (in the upper left corner), or the third quadrat (in the lower left corner) of X-Y coordinate system from the original projected position. Any shifted moving to obtain the first mesh pattern 12 and the second mesh pattern 13 arranged in staggered arrangement can be implemented in the present invention. The present invention is not limited to the above embodiments.

Comparing with the above embodiments, in this embodiment, the first mesh pattern 12 and the second mesh pattern 13 have the turning points selected randomly, and further have the nodes capable of being randomly selected corresponding to the referring nodes arranged in regular order. Due to each first mesh node 121′ is limited in the shiftable zone A1 corresponding to each first referring nodes 121, when two first mesh patterns 12 are spliced together, the first referring nodes 121 located at the interfaces thereof are facilitated to splice together. Along the interface of two adjacent first mesh patterns 12, each first mesh node 121′ is disposed and limited in the corresponding shiftable zone A1, and the size of the shiftable zone A1 is controllable (i.e. the shiftable zone A1 can be controlled by determining the first predetermined radii R1 and the second predetermined radii R2). Consequently, there won't be abnormal opening and spliced mark generated in the spliced interface of the mesh patterns. In some embodiments, the first mesh nodes 121′ located at the boundary can be respectively determined by the original position of the first referring nodes 121 and arranged in regular order, so as to facilitate to splice plural first mesh patterns 12 and avoid the spliced mark generated between the spliced interfaces.

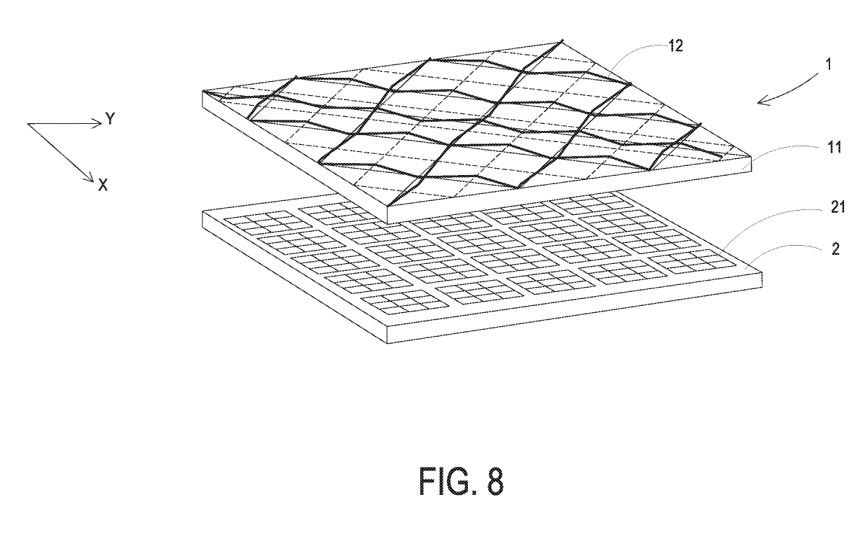

In some embodiments, the plural first referring nodes 121 disposed on the first surface 111 and the plural second referring nodes 131 disposed on the second surface 112 can be respectively arranged as but not limited to triangular arrays, square arrays, rectangle arrays, hexagonal arrays or octagonal arrays. In this embodiment, the plural first referring nodes 121 and the plural second referring nodes 131 are arranged as the diamond arrays, but the present invention is not limited to this embodiment. FIG. 8 schematically illustrates the relative arrangement of the metal mesh sensing module of FIG. 1 and the pixel units of a display module according to a preferred embodiment of the present invention. As shown in FIG. 8, each first mesh pattern 12 or each second mesh pattern 13 of the metal mesh sensing module 1 are corresponding to the pixel units 21 of the display module 2. The pixel units 21 are consisted of red pixel units, green pixel units and blue pixel units. In some embodiment, a display panel 2 includes the pixel units 21 arranged in different zones. For minimizing the Moire effect and the interference caused by the arrangement of the pixel units, the first referring nodes 121 and the second referring nodes 131 can be defined as different arrays in different zones according to the arrangements and zones of the pixel units of the display panel 2. Each first mesh pattern 12 and each second mesh pattern 13 have the length larger than that of each pixel unit 21.

In summary, the present invention provides a metal mesh sensing module of a touch panel and a manufacturing method thereof. By randomly designing the mesh pattern of the metal mesh sensing module, the possibility of generating the interference caused by the overlapping or cross points of patterns is avoided. In addition, the possibility of generating the mesh opening with abnormal aperture ratio and unequal distribution in random-designed patterns will be avoided by controlling the random designed mesh pattern of the metal mesh sensing module precisely in a specific condition. Consequently, the phenomenon of uneven light intensity will be avoided while the metal mesh sensing module is applied to a touch display apparatus. On the other hand, since the random designed patterns of the metal mesh sensing module can be controlled precisely by using specific shiftable zone, there won't be abnormal opening and spliced mark generated in the spliced interface of the mesh patterns while more than two random-designed mesh patterns are spliced together. Consequently, the interference caused by the interface between two spliced patterns is avoided, and the visibility is not influenced. The mesh patterns can be designed according to the arrangement of pixel units in a display panel for reducing the Moire effect and enhancing the visibility.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A metal mesh sensing module of a touch panel, comprising:
a transparent substrate having a first surface and a second surface;
at least a first mesh pattern disposed on the first surface and having plural first referring nodes, plural first referring points, and plural first turning points, wherein the plural first referring nodes are arranged in regular order, and each first referring point is located at the midpoint between two adjacent first referring nodes; and
at least a second mesh pattern disposed on the second surface and having plural second referring nodes and plural second referring points, wherein the plural second referring nodes are arranged in regular order, and each second referring point is located at the midpoint between two adjacent second referring nodes; wherein the plural first referring nodes and the plural second referring nodes have their vertical projections in staggered arrangement, and the plural first referring points and the plural second referring points have the same vertical projections;
wherein each first referring point is corresponding to a shiftable zone, and each first turning point is randomly selected from the shiftable zone having the center aligned to the corresponding first referring point on the first surface, wherein each first referring node is connected to the adjacent first turning points on the first surface, so as to form the first mesh pattern.

2. The metal mesh sensing module according to claim 1, wherein the second mesh pattern comprises plural second turning points, and each second turning point is randomly selected from the shiftable zone having the center aligned to the corresponding second referring point, wherein each second turning point is connected with adjacent second referring nodes on the second surface, so as to form the second mesh pattern.

3. The metal mesh sensing module according to claim 1, wherein the second mesh pattern comprises plural second turning points disposed on the second surface, the plural second turning points and the plural first turning points have the same vertical projections, and each second turning point is connected with adjacent second referring nodes on the second surface, so as to form the second mesh pattern.

4. The metal mesh sensing module according to claim 1, wherein the second mesh pattern and the first mesh pattern have the same vertical projection after the second mesh pattern is horizontally moved a shifted distance, wherein the shifted distance is a projection distance between any first referring node and any second referring node.

5. The metal mesh sensing module according to claim 1, wherein the second mesh pattern comprises plural second mesh nodes and plural second turning points, wherein each second mesh node is randomly selected from the shiftable zone having the center aligned to the corresponding second referring node, and each second turning point is randomly selected from the shiftable zone having the center aligned to the corresponding second referring point, wherein each second mesh node is connected to adjacent second turning points on the second surface, so as to form the second mesh pattern.

6. The metal mesh sensing module according to claim 1, wherein the shiftable zone is a circumference or a circle area defined by a predetermined radii, and the predetermined radii and the distance between any two adjacent first referring nodes or any two adjacent second referring nodes have a specific ratio ranged from 0.5% to 12.5%.

7. The metal mesh sensing module according to claim 6, wherein the predetermined radii and the distance between any two adjacent first referring nodes or any two adjacent second referring nodes have the specific ratio ranged from 1% to 10%.

8. The metal mesh sensing module according to claim 1, wherein the shiftable zone is two circumferences or a ring area defined by a first predetermined radii and a second predetermined radii, a specific ratio of the first predetermined radii or the second predetermined radii to the distance between any two adjacent first referring nodes or any two adjacent second referring nodes is ranged from 0.5% to 12.5% and the first predetermined radii is larger than the second predetermined radii.

9. The metal mesh sensing module according to claim 8, wherein the first predetermined radii and the distance between any two adjacent first referring nodes or any two adjacent second referring nodes have the specific ratio ranged from 1% to 10%.

10. A manufacturing method of a metal mesh sensing module, comprising steps of:
(a) defining plural first referring nodes and plural first referring points on a first surface, wherein plural first referring nodes are arranged in regular order, and each first referring point is located at the midpoint between two adjacent first referring nodes;
(b) defining plural second referring nodes and plural second referring points on a second surface, wherein plural second referring nodes are arranged in regular order, and each second referring point is located at the midpoint between two adjacent second referring nodes; wherein the plural first referring nodes and the plural second referring nodes have their vertical projections in staggered arrangement, and the plural first referring points and the plural second referring points have the same vertical projections;
(c) defining a shiftable zone corresponding to each first referring point, and obtaining plural first turning points, wherein each first turning point is randomly selected from the shiftable zone having the center aligned to the corresponding first referring point; and
(d) connecting each first referring node to adjacent first turning points and obtaining a first mesh pattern disposed on the first surface.

11. The manufacturing method according to claim 10, further comprising steps of:
(e) aligning the center of the shiftable zone to each second referring point, and obtaining plural second turning points, wherein each second turning point is randomly selected from the shiftable zone having the center aligned to the corresponding second referring point; and
(f) connecting each second referring node to the adjacent second turning points and obtaining a second mesh pattern disposed on the second surface.

12. The manufacturing method according to claim 10, further comprising steps of:
(e) projecting the first mesh pattern on the second surface; and
(f) obtaining a second pattern by horizontally moving the projected first mesh pattern a shifted distance, wherein the shifted distance is a projection distance between any first referring node and any second referring node.

13. The manufacturing method according to claim 10, further comprising steps of:
(e) obtaining plural second turning points on the second surface, wherein the plural second turning points and the plural first turning points have the same vertical projections; and
(f) connecting each second referring node to adjacent second turning points and obtaining a second mesh pattern disposed on the second surface.

14. The manufacturing method according to claim 10, further comprising steps of:
(e) aligning the center of the shiftable zone to each second referring node, and obtaining plural second mesh nodes and plural second turning points, wherein each second mesh node is randomly selected from the shiftable zone having the center aligned to the corresponding second referring node and the plural second turning points and the plural first turning points have the same vertical projections; and
(f) connecting each second node to adjacent second turning points and obtaining a second mesh pattern disposed on the second surface.

15. The manufacturing method according to claim 10, wherein the step (c) further comprising step (c1) of aligning the center of the shiftable zone to each first referring node, and obtaining plural first mesh nodes, wherein each first mesh node is randomly selected from the shiftable zone having the center aligned to the corresponding first referring node located at the center thereof; and step (d) further comprising step (d1) connecting each first mesh node to adjacent first turning points and obtaining the first mesh pattern disposed on the first surface.

16. The manufacturing method according to claim 10, wherein the shiftable zone is a circumference or a circle area defined by a predetermined radii, and the predetermined radii and the distance between any two adjacent first referring nodes or any two adjacent second referring nodes have a specific ratio ranged from 0.5% to 12.5%.

17. The manufacturing method according to claim 16, wherein the predetermined radii and the distance between any two adjacent first referring nodes or any two adjacent second referring nodes have the specific ratio ranged from 1% to 10%.

18. The manufacturing method according to claim 10, wherein the shiftable zone is two circumferences or a ring area defined by a first predetermined radii and a second predetermined radii, a specific ratio of the first predetermined radii or the second predetermined radii to the distance between any two adjacent first referring nodes or any two adjacent second referring nodes is ranged from 0.5% to 12.5% and the first predetermined radii is larger than the second predetermined radii.

19. The manufacturing method according to claim 18, wherein the first predetermined radii and the distance between any two adjacent first referring nodes or any two adjacent second referring nodes have the specific ratio ranged from 1% to 10%.
